(19) United States
(12) Patent Application Publication
(10) Pub. No.: US 2001/0009241 A1
(43) Pub. Date: Jul. 26, 2001

(54) Pipe-laying vehicle

(76) Inventor: Alois Johann Haringer, Neumarkt (IT)

Correspondence Address: FASSE PATENT ATTORNEYS, P.A., P.O. BOX 726, HAMPDEN, ME, 04444-0726, US

(21) Appl. No.: 09/765,237

(22) Filed: Jan. 16, 2001

(30) Foreign Application Priority Data
Jan. 25, 2000 (DE) 100 03 058.0
May 15, 2000 (EP) 001 10 185.6

(51) Int. Cl. B66C 23/76

(52) U.S. Cl. 212/196; 212/168

(57) ABSTRACT

The pipe-laying vehicle 1 possesses a lower vehicle body 2 with a driver's cab and a jib 10 which is supported on the lower vehicle body 2 and can be raised and lowered about a horizontal axis of inclination 11. In addition, the jib 10 can be swivelled about a vertical pivot axis by means of a live ring. On the outer end of the jib 10, a sheave head 31 is provided with a deflection pulley 26 and a sheave 28, and can be swivelled as a whole about an adjustment axis 32 relative to the jib 10. This adjustment axis 28 extends in the longitudinal direction of the jib 10. By means of a mechanically or hydraulically actuated locking device, the pivot position of the sheave head 31 relative to the jib 10 can also be locked. As a result of the swivel capability both of the jib 10 and of the sheave head 31, the pipe laying work can be performed more simply and quickly.

The invention relates to a pipe-laying vehicle having a lower vehicle body, a driver's cab or driver's stand, a jib, which possesses at its outer end a sheave head with a sheave, and having drive mechanisms for movement, for raising and lowering the jib and for winding up and unwinding the supporting cable running over the sheave.

Such a pipe-laying vehicle, which is used in the construction of pipe lines laid below the surface of the earth, is known. In such vehicles, the jib, articulated on the lower vehicle body by means of a horizontal axle, can be displaced only within a vertical plane which is determined by the vehicle. The alignment of the pipes, supported essentially horizontally by the jib, is performed by appropriate manoeuvring of the lower vehicle body. The sheave head, in which a deflection pulley for the supporting cable and the upper sheave of a block and tackle are mounted, is fixedly connected by welding to the outer end of the jib. A consequence of this rigid connection of the sheave head to the jib is that the sheave head and the two sheaves mounted therein are always situated in the vertical plane in which the more or less steeply inclined jib also extends. In order, when suspending the load, to orient the sheave head towards the pipe to be suspended and, moreover, to set down the pipe in the intended position of installation, it is therefore necessary for the jib to be brought into an appropriately oriented position by manoeuvring the pipe-laying vehicle. This working procedure, in which the pipe-laying vehicle also has to be moved and manoeuvred when the pipe to be laid is to be turned only through a small angle relative to the ground or is not located approximately vertically below the sheave head, is elaborate and time-consuming.

Accordingly, the object of the invention is to design the pipe-laying vehicle in such a way that it is better adapted to the requirements to be met and permits simpler and more rapid working.

This object is achieved, according to the invention, in that the jib can be swivelled by means of a swivel drive relative to the lower vehicle body about a pivot axis standing perpendicular to the lower vehicle body and in that the sheave head is mounted to swivel on the jib about an adjustment axis.

The swivelling according to the invention of the jib about a vertical axis, which is expediently achieved by supporting the jib on the lower vehicle body via a live ring, offers the possibility, with the vehicle stationary and, if appropriate, stabilized, of laying pipes within a circumference determined by the range of the inclinable jib and aligning them with a pipe trench—which is done by the interplay of swivel movements and changes of inclination of the jib and winding up or unwinding the supporting cable. The swivelling of the sheave head relative to the jib allows limited swivelling of the sheave head to left or right, out of the vertical plane of the jib, in order to set the sheave head for a load located off to one side on the ground, so that this load can easily be suspended from the jib and pulled across the ground to the vertical plane of the jib. The automatic setting of the swivelling sheave head for the load to be suspended, or its position, also has the particular advantage that the supporting cable extends from the sheave head towards the load in a direction which deviates to a lesser extent, if at all, from the sheave plane. As a result, the friction between the supporting cable and the sheaves is reduced and smooth running of the cable over the sheaves is enhanced, without any cause for fear that the cable may jump out of the circumferential grooves of the sheaves. When the lifted pipe is set down, also, this can be more simply and reliably controlled under the action of transverse forces, enabling it to be set down wholly or partially outside the plane of the jib. Accordingly, the swivelling of the sheave head relative to the jib also simplifies the work of pipe laying.

However, the swivelling of the sheave head is not always desirable. Consequently, a further development envisages assigning to the sheave head a locking device which permits the fixing of the sheave head in its central position or in a position swivelled out of this central position to one side or the other.

This locking device may be so designed that it simultaneously restricts the swivelling of the sheave head to a particular angular range. The actuation of the locking device may be mechanical, hydraulic or pneumatic. The hydraulic blocking and releasing of the locking device suggests itself if a hydraulic device is already present to actuate the jib of the pipe-laying vehicle, particularly since convenient remote actuation of the locking device can also be achieved in this manner.

Further expedient embodiments and further developments of the invention are disclosed in the dependent claims.

Examples of embodiment of the invention will be described below in detail with reference to a diagrammatic drawing, in which:

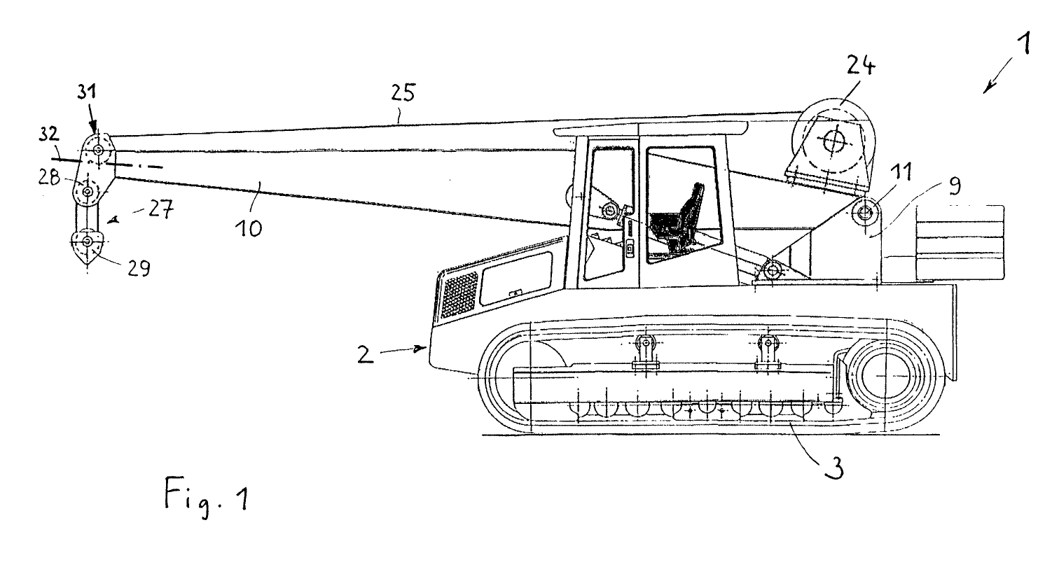

FIG. 1 shows a lateral view of a pipe-laying vehicle with the jib lowered in the position of rest or transport position;

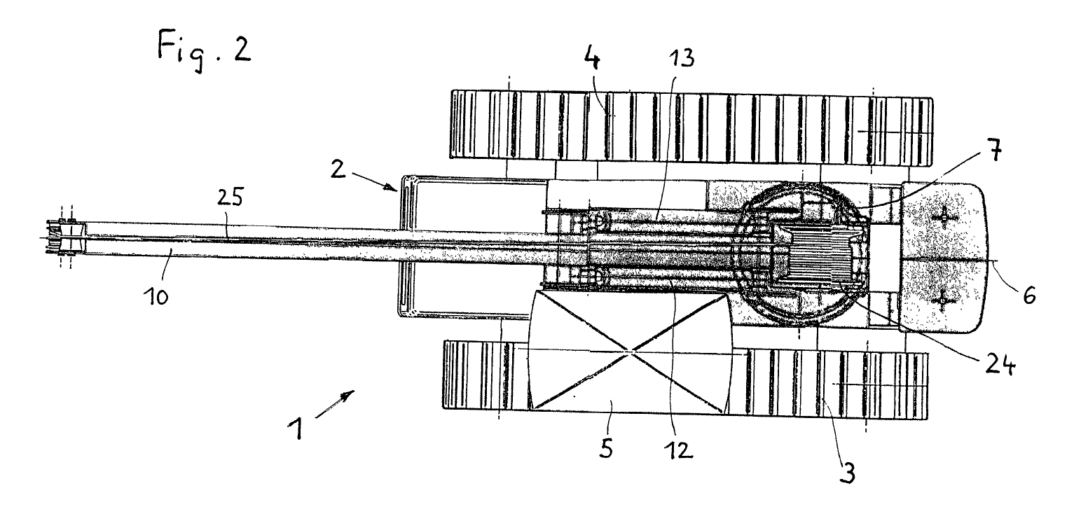

FIG. 2 shows a plan view of the pipe-laying vehicle according to FIG. 1;

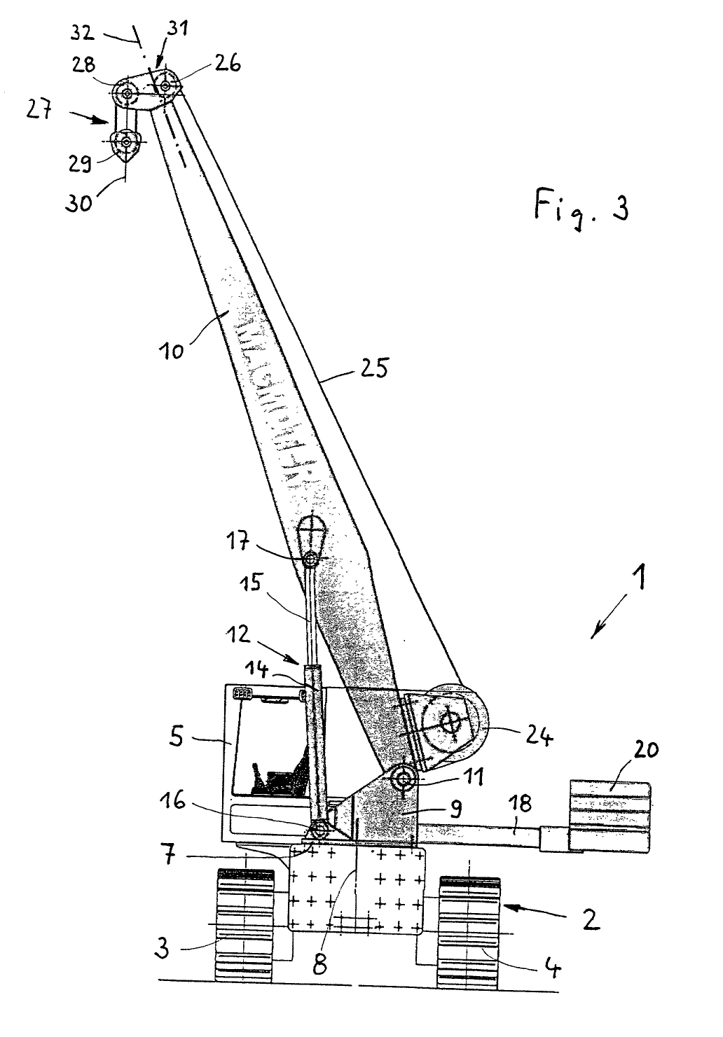

FIG. 3 shows an end-on view of the pipe-laying vehicle with the jib raised and swivelled into a working position;

FIG. 4 shows a plan view of the pipe-laying vehicle shown in FIG. 3;

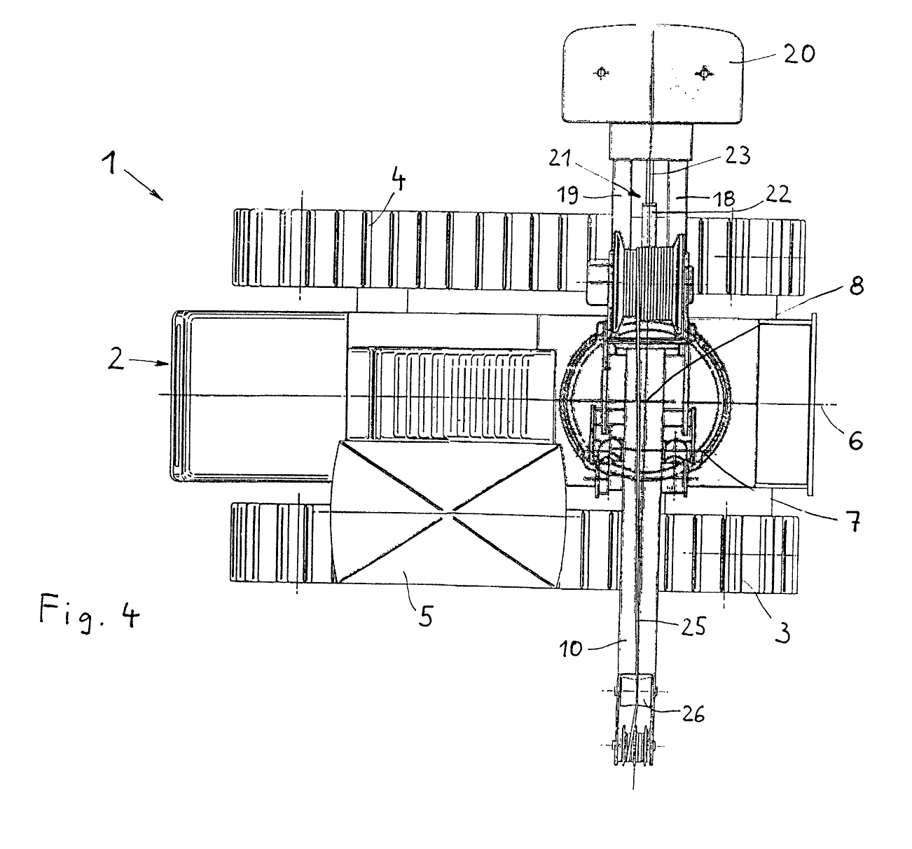

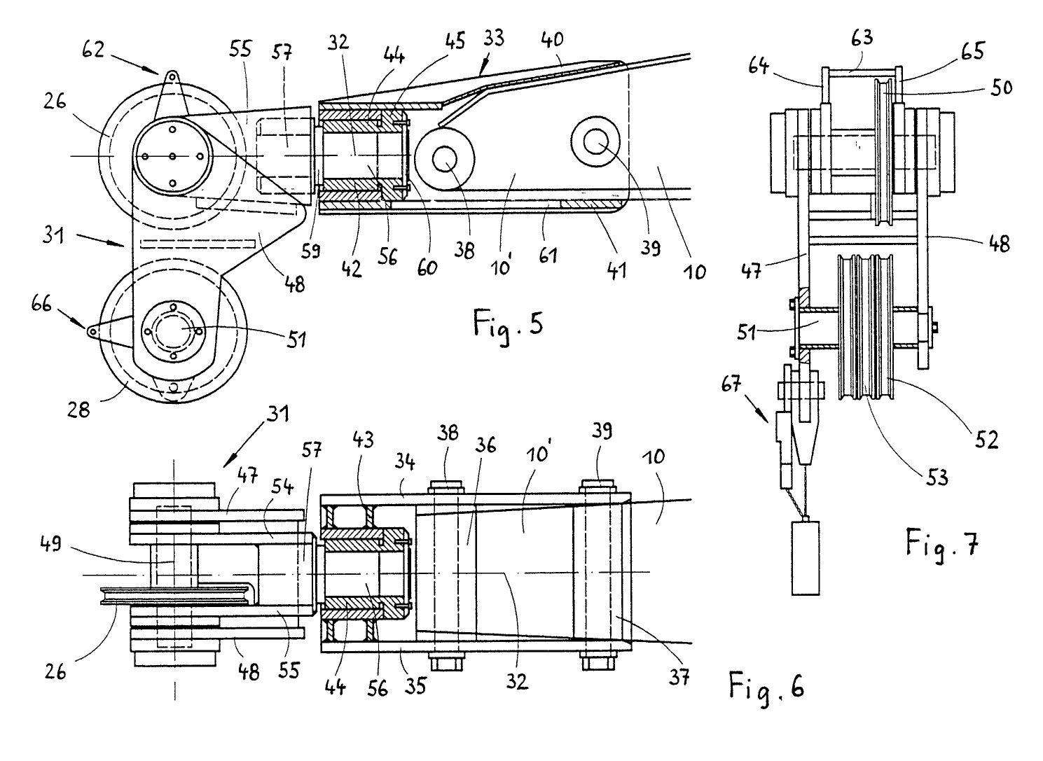

FIG. 5 shows the sheave head and the outer end of the jib, pivoted down into the horizontal position, in a partially sectioned lateral view;

FIG. 6 shows the arrangement according to FIG. 5 in a partially sectioned plan view;

FIG. 7 shows the arrangement according to FIG. 5 in a partially sectioned end-on view from the left;

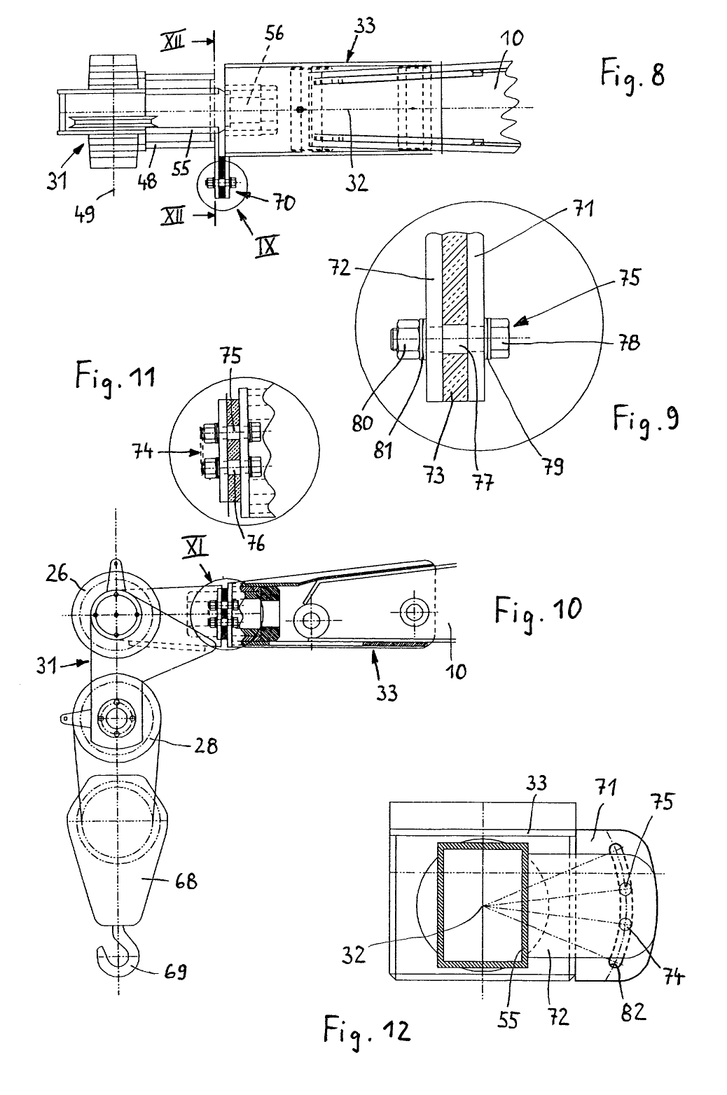

FIG. 8 shows a plan view of an arrangement corresponding to FIGS. 5 to 7, additionally provided with a mechanical locking device;

FIG. 9 shows detail IX in FIG. 8 on an enlarged scale;

FIG. 10 shows a lateral view of the arrangement according to FIG. 8;

FIG. 11 shows the detail XI in FIG. 10 on an enlarged scale;

FIG. 12 shows an enlarged sectional view along the line XII-XII in FIG. 8;

FIG. 13 shows a view corresponding to FIG. 8 but with a hydraulically actuated locking device;

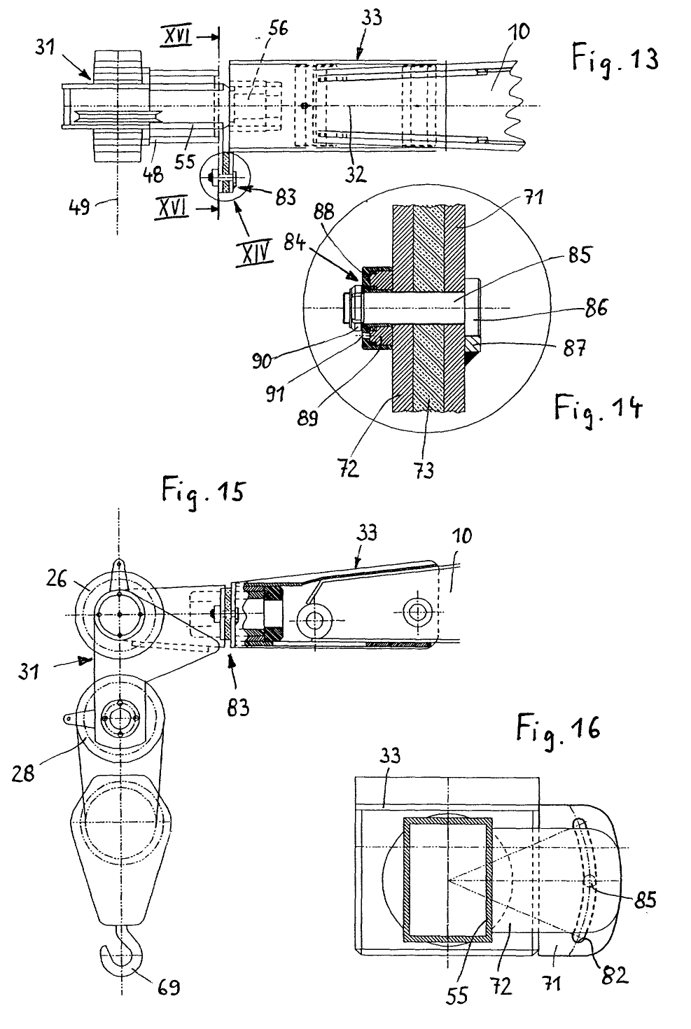

FIG. 14 shows the detail XIV in FIG. 13 on an enlarged scale;

FIG. 15 shows a lateral view of the arrangement according to FIG. 13; and

FIG. 16 shows a section along the line XVI-XVI in FIG. 13 on an enlarged scale.

The pipe-laying vehicle 1 according to FIGS. 1 to 4 shows a lower vehicle body 2, designed as a tracked vehicle having lateral drive chains 3 and 4, and possessing a driver's cab 5 which is arranged at a distance to the left of the longitudinal median plane 6 of the lower vehicle body 2.

A live ring 7 having a vertical pivot axis 8 is arranged centrally behind the driver's cab S on the lower vehicle body 2 and supports a superstructure. The live ring 7 or the superstructure can be swivelled by means of a pivot drive (not shown) and comprises a jib base 9, on which a jib 10 is articulated with a horizontal axis of inclination 11. In order to raise and lower the jib, two parallel hydraulic units 12 and 13 are provided, each having a cylinder 14 and a piston rod 15, which are articulated on the jib base 9 or on the jib 10 with axes 16 and 17 parallel to the axis of inclination 11.

Connected to the jib base 9 by means of two horizontal telescopic guides 18 and 19 which extend approximately radially to the pivot axis 8 and in a diametrically opposite direction to the jib 10 is a counterweight 20, whose distance from the pivot axis 8 can be set by means of an adjustment device 21. The adjustment device 21 is likewise hydraulically actuated and possesses a cylinder 22 and a piston rod 23 that extend centrally between the two telescopic guides 18 and 19.

At its inner, articulated end, the jib 10 bears a winding drum 24, which can be reversibly driven by means of a drive mechanism (not shown), for a supporting cable 25 which is connected via a deflection pulley 26 at the free end of the jib 10 to a block and tackle 27 having an upper sheave 28. The moveable (lower) sheave arrangement 29 of the block and tackle 27 is connected to a suspension apparatus 30 for pipes, indicated only as a cable section. The deflection pulley 26 and the sheave 28 are mounted in a sheave head 31, which in turn is mounted at the outer end of the jib 10 to swivel about an adjustment axis 32.

FIGS. 1 and 2 show the jib 10 with the hydraulic units 12 and 13 retracted and the adjustment device 21 retracted in its position of rest, in which the jib 10 extends approximately horizontally forwards in the longitudinal median plane 6. This position of rest is also the position in which the pipe-laying vehicle 1 is transported to its place of use and back.

As FIG. 3 shows, the jib 10 can be raised into an upright position in which it can be pivoted about the pivot axis 8, over the driver's cab 5, into a working position. The counterweight 20, which according to FIGS. 3 and 4 has been moved out to a greater distance from the pivot axis 8, would however collide with the driver's cab 5 in the event of appropriate further pivoting. Accordingly, the pivot range of the jib 10 is limited. This limitation is less if the jib 10, in the raised position, can be pivoted away over the driver's cab 5, and can be avoided altogether if the driver's cab is also supported on the live ring (not shown) and is thus swivelled together with the jib 10. Swivelling through at least 270° about the pivot axis 8 is desirable.

According to FIGS. 5 and 7, an intermediate piece 33 is connected to the outer end 10′ of the jib 10 and possesses two parallel bearing plates 34 and 35 which are fixed in their respective positions by two spacer sleeves 36 and 37 and by securing bolts 38 and 39 extending through the latter. The intermediate piece 33 also has contact plates 40 and 41 between the bearing plates 34 and 35 whose shape and size are adapted to the outer end of the jib 10, so that the box-shaped intermediate piece 33 can be pushed onto the outer end of the jib 10, as can be seen in FIG. 5, and can be fixedly clamped thereto by means of the securing bolts 38, 39, as can be seen from FIG. 6.

A bearing cylinder 42 is inserted into the end of the intermediate piece 33 remote from the jib 10 and is welded to the contact plates 40 and 41 directly and to the bearing plates 34 and 35 via a plurality of radial struts 43. A bearing bush 44 consisting of a slip material having a low coefficient of friction is inserted into the bearing cylinder 42 and possesses a radial flange 45 engaging onto the bearing cylinder 42 at the end face.

The bearing bush 44 serves for the swivelling mounting of the sheave head 31, which possesses two parallel bearing plates 47, 48, between which are mounted the deflection pulley 26, on an axle 49, and the sheave 28 with a number of circumferential grooves 53 on an axle 51. The supporting cable 25, not shown in FIGS. 5 to 7, passes from the sheave 28 over the single-grooved deflection pulley 26 and onwards along the jib 10—at a short distance above the jib 10 in the illustration according to FIG. 5—to the winding drum 24 near the inner end of the jib 10.

The axle 49 of the deflection pulley 26 is mounted in two parallel securing plates 54, 55, so that the sheave 28 and its axle 51 can pivot about the axle 49 of the deflection pulley 26. Without the action of external forces, the sheave 28 hangs vertically below the deflection pulley 26 under the action of gravity, as shown by FIG. 5.

The two securing plates 54, 55 are connected to a bearing journal 56, which possesses an enlarged journal head 57 provided with flattened circumferential portions, the journal head 57 being arranged between the two securing plates 54, 55 and fixedly welded thereto. The bearing journal 56 is mounted in the bearing bush 44 so that the entire sheave head 31 can be swivelled about the adjustment axis 28. This extends in the longitudinal direction of the jib 10.

For the axial securing of the bearing journal 56 in the bearing bush 44, the bearing journal 56 possesses a journal collar 59 at the transition to the journal head 57, engaging over one end face of the bearing bush 44. Furthermore, a stop part 60 is connected to the bearing journal 56, for example by means of a screw, and engages over the other end face of the bearing bush 44. The screw and the stop part 60 are accessible via a recess 61 in the contact plate 41. The distance between the stop part 60 and the journal collar 59 guarantees an adequate axial bearing play of the bearing journal 56.

Assigned to the deflection pulley 26 is a cable depressor 62, which according to FIG. 7 is formed by two radially projecting securing tabs 64, 65 and a retaining rod 63 extending between them. A corresponding cable depressor 66 is assigned to the sheave 28 with the circumferential grooves 53.

As shown in FIG. 7, a depending actuating device 67 is connected to the bearing plate 47 of the sheave head 31 and enables the sheave head 31 to be swivelled by hand, to a limited extent, about the adjustment axis 32. In the same manner, the sheave 28 can also be swivelled to a limited extent about the axle 49 and thereby moved out of a position vertically below the deflection pulley 26.

FIGS. 8 and 10 show the arrangement of a sheave head 31 on the jib 10 with the use of an intermediate piece 33, this arrangement largely coinciding with the arrangement described in accordance with FIGS. 5 to 7, so that the same reference numerals are provided for corresponding parts. FIG. 10 also shows the suspended carrier piece 68 with the load hook 69.

The essential difference in the embodiment according to FIGS. 5 to 7 resides in the fact that, in addition, a mechanical locking device 70 is provided, with the aid of which the respective pivot position of the sheave head 31, and especially its median position relative to the jib 10, can be fixed.

To this locking device 70 belong a locking plate 71, which is fixedly welded to the intermediate piece 33 and projects laterally on one side from this intermediate piece 33, and a pivot plate 72 which is fixedly connected to the sheave head 31 or to the bearing plate 48 and securing plate 55 and similarly projects laterally on one side. As particularly shown in the enlarged FIGS. 9, 11 and 12, the two plates 71 and 72 extend parallel to one another and enclose between them a plate-shaped intermediate layer 73 which consists of a friction material.

A clamping device 74 possesses two clamping bolts 75 and 76, which extend through the two plates 71, 72 and the intermediate layer 73 and are each formed by a clamping screw 77 which, according to FIG. 9, is supported by its head 78 via a sprung ring 79 on the outside of the locking plate 71. Screwed onto the clamping screw 77 is a clamping nut 80 which rests, via a sprung ring 81, on the outside of the pivot plate 72. By tightening the two clamping nuts 80, the two plates 71 and 72 can be clamped together in a manner proof against rotation, as a result of which the ability of the sheave head 31 to swivel is eliminated until the two clamping nuts are released.

The clamping bolts 75 and 76 extend with only slight play through drilled holes in the pivot plate 72 and in the intermediate layer 73. By contrast, the locking plate 71, as can be seen in FIG. 12, possesses a slit 82 to receive the clamping bolts 75 and 76, extending in an arcuate manner about the adjustment axis 32 of the sheave head 31. This slit 82 makes it possible, with the clamping nuts 80 released, to swivel the pivot plate 72 relative to the locking plate 71 and hence the sheave head 31 relative to the jib 10. The length of the slit 82 here restricts the pivot range, since its ends interact as a stop with the clamping bolts 75 and 76. This pivot range should be at least 45°.

The design according to FIGS. 13 to 16 largely corresponds to that according to FIGS. 8 and 12, but a hydraulically actuated locking device 83 is provided instead of the mechanically actuated locking device 70. This largely coincides with the locking device 70, and accordingly, in FIGS. 14 and 16, the same reference numerals are provided for the locking plate 71, the pivot plate 72, the intermediate layer 73 and the slit 82 in the locking plate 71.

The clamping device 84 is of different design. It 5 possesses only a single clamping bolt 85, which bears with its head 86 directly on the locking plate 71 and rests on a carrier piece 87 welded onto the locking plate 71.

Placed on the end of the clamping bolt 85 remote from the head 86 is an annular clamping cylinder 88 of approximately U-shaped cross section, open towards the pivot plate 72, which receives a correspondingly annular pressure piston 89 and is secured on the clamping bolt 85 by a nut 90 screwed onto the bolt end and fixed. This nut 90 is not a clamping nut like the clamping nut 80 according to FIG. 9 but forms an abutment for the clamping cylinder 88.

The clamping cylinder 88 is provided at its end face with a stop 91 for a hydraulic line (not shown). If hydraulic fluid is supplied via this line, the clamping cylinder 88 is supported on the nut 90 and the pressure piston 89 is extended so that the plates 71 and 72 are pressed against the intermediate layer 73 and thereby clamped together in a manner proof against rotation.

1. Pipe-laying vehicle having a lower vehicle body (2), a driver's cab (5) and a jib (10), which possesses at its outer end a sheave head (31) with at least one sheave (26), and having drive mechanisms for movement, for raising and lowering the jib (10) and for winding up and unwinding the supporting cable (25) running over the sheave (26), characterized in that the jib (10) can be swivelled by means of a swivel drive relative to the lower vehicle body (2) about a pivot axis (8) standing perpendicular to the lower vehicle body (2) and in that the sheave head (31) is mounted to swivel on the jib (10) about an adjustment axis (32).

2. Pipe-laying vehicle according to claim 1, characterized in that the swivel drive comprises a live ring (7) on which the jib (10) is positioned.

3. Pipe-laying vehicle according to claim 1 or 2, characterized in that a counterweight (20) is assigned to the jib (10) and its load, its distance from the pivot axis (8) being capable of being set by means of an adjustment device (21).

4. Arrangement according to one of claims 1 to 3, characterized in that the adjustment axis (32) of the sheave head (31) extends in the longitudinal direction of the jib (10).

5. Arrangement according to one of claims 1 to 4, characterized in that the pivot bearing (44, 56) of the sheave head (31) possesses a bearing journal (56) and a bearing bush (44) which are connected respectively to the sheave head (31) and to the jib (10) the bearing journal (56) possessing a journal collar (59) engaging over one end face of the bearing bush (44), and a stop part (60) being connected to the bearing journal (56) and engaging over the other end face of the bearing bush (44).

6. Arrangement according to one of claims 1 to 5, characterized in that the sheave head 31 possesses two parallel bearing plates (47, 48) between which are mounted a deflection pulley (26) for the supporting cable (25) and the upper sheave (28) of a block and tackle (27) with the load suspension apparatus (30).

7. Arrangement according to one of claims 1 to 6, characterized in that a locking device (70, 83) is assigned to the sheave head (31) in order to fix the sheave head (31) in its pivot position within the swivel range.

8. Arrangement according to claim 7, characterized in that the locking device (70, 83) possesses a locking plate (71) projecting laterally from the jib (10) or from an intermediate piece (33) fixedly connected thereto and a laterally projecting pivot plate (72) fixedly connected to the swivelling sheave head (31), the two plates (71, 72) extending parallel and being arranged to overlap one another at a short distance apart, enclosing an intermediate layer (73) of a material with a high coefficient of friction, and being capable of being clamped together by means of a clamping actuating device (80; 88, 89).

9. Arrangement according to claim 7 or 8, characterized in that a clamping device (88, 89) capable of remote hydraulic actuation and having a clamping cylinder (88) and a pressure piston (89) is assigned to the locking device (83).

10. Pipe-laying vehicle according to one of claims 1 to 9, characterized in that the jib (10) can be swivelled through at least 270° relative to the lower vehicle body (2) and the sheave head (31) through at least 45° relative to the jib (10).
